(19) United States
(12) Patent Application Publication
(10) Pub. No.: US 2023/0364645 A1
(43) Pub. Date: Nov. 16, 2023

(54) ULTRASONIC MOTOR

(71) Applicant: Murata Manufacturing Co., Ltd., Nagaokakyo-shi (JP)

(72) Inventors: Tsuguji KAMBAYASHI, Nagaokakyo-shi (JP); Hiroshi ASANO, Nagaokakyo-shi (JP); Hideaki KASHIURA, Nagaokakyo-shi (JP)

(21) Appl. No.: 18/358,436

(22) Filed: Jul. 25, 2023

Related U.S. Application Data
(63) Continuation of application No. PCT/JP2022/003140, filed on Jan. 27, 2022.

(30) Foreign Application Priority Data
Feb. 17, 2021 (JP) 2021-023230

(51) Int. Cl. B06B 1/06; H02N 2/10; H02N 2/12

(52) U.S. Cl. CPC B06B 1/0644; H02N 2/103; H02N 2/12

(57) ABSTRACT

A device may include a stator including a vibrating body in a plate shape having a first principal surface and a second principal surface opposed to each other, and including a piezoelectric device provided on the first principal surface of the vibrating body. A device may include a rotor directly or indirectly in contact with the second principal surface of the vibrating body. A device may include a spring in a plate shape having an opening and configured to give elastic force to the rotor in a direction from a side of the rotor to a side of the stator. A device may include a shaft inserted into the opening of the spring and having a mating portion, wherein. A device may include a shape of the opening of the spring is a noncircular shape in a plan view.

### CROSS REFERENCE TO RELATED APPLICATIONS

This application is a continuation of International Application No. PCT/JP2022/003140, filed Jan. 27, 2022, which claims priority to Japanese Patent Application No. 2021-023230, filed Feb. 17, 2021, the entire contents of each of which are hereby incorporated by reference in their entirety.

### TECHNICAL FIELD

The present disclosure is directed to an ultrasonic motor.

### BACKGROUND OF THE INVENTION

Conventionally, various ultrasonic motors which vibrate a stator by a piezoelectric device have been proposed. Japanese Unexamined Patent Application Publication No. 2001-054288 (the “'288 Publication”) discloses one example of an ultrasonic motor. In this ultrasonic motor, a disc spring presses a rotor to bring the rotor and the stator to contact closely. A collar is assembled to the center of the rotor. The collar includes a plurality of convex portions, whereas the disc spring includes a plurality of concave portions. The plurality of convex portions of the collar and the plurality of concave portions of the disc spring mate with each other, and the disc spring is positioned. In this manner, pressure is attempted to be applied to the rotor and the stator uniformly in a circumferential direction. Moreover, the rotor is fixed to a rotating shaft with the collar interposed therebetween.

In the ultrasonic motor of the '288 Publication, the rotating shaft, the rotor, the collar, and the disc spring are complexly combined together. However, when stress caused by vibration or heat is continuously applied during long-term use, loosening may be caused at a portion where the members closely contact with each other, which may cause misalignment, for example, between the rotating shaft and the disc spring. Therefore, abnormal noise may be caused due to contact between the members.

### SUMMARY OF INVENTION

According to an aspect of the disclosure is to provide an ultrasonic motor which is less likely to cause misalignment between a spring member and a shaft member.

An ultrasonic motor according to the present disclosure includes: a stator including a vibrating body in a plate shape having a first principal surface and a second principal surface opposed to each other, and including a piezoelectric device provided on the first principal surface of the vibrating body; a rotor directly or indirectly in contact with the second principal surface of the vibrating body; a spring member in a plate shape having an opening and configured to give elastic force to the rotor in a direction from a side of the rotor to a side of the stator; and a shaft member inserted into the opening of the spring member and having a mating portion. A shape of the opening of the spring member is a noncircular shape in a plan view. The spring member has a convex portion bent in a direction from the side of the stator to the side of the rotor, and an opening edge portion of the opening mates with the mating portion of the shaft member, the opening edge portion being a tip-end portion of the convex portion.

According to the ultrasonic motor of the present disclosure, misalignment is less likely to be caused between the spring member and the shaft member.

### BRIEF DESCRIPTION OF DRAWINGS

In the descriptions that follow, like parts are marked throughout the specification and drawings with the same numerals, respectively. The drawings are not necessarily drawn to scale and certain drawings may be shown in exaggerated or generalized form in the interest of clarity and conciseness. The disclosure itself, however, as well as a mode of use, further features and advances thereof, will be understood by reference to the following detailed description of illustrative implementations of the disclosure when read in conjunction with reference to the accompanying drawings, wherein:

FIG. 1 is an elevational sectional view of an ultrasonic motor in accordance with aspects of the present disclosure;

FIG. 2 is an exploded perspective view of the ultrasonic motor in accordance with aspects of the present disclosure;

FIG. 3 is a plan view of a spring member in accordance with aspects of the present disclosure;

FIG. 4 is an enlarged view of a portion where the spring member and a shaft member mate with each other in FIG. 1;

FIG. 5 is a bottom view of a stator in accordance with aspects of the present disclosure;

FIG. 6 is an elevational sectional view of a first piezoelectric device in accordance with aspects of the present disclosure;

FIGS. 7(a) to 7(c) are schematic bottom views of the stator for illustrating a traveling wave excited in accordance with aspects of the present disclosure;

FIG. 8 is a plan view of a spring member in a first modification in accordance with aspects of the present disclosure;

FIG. 9 is an elevational sectional view of a spring member in a second modification in accordance with aspects of the present disclosure;

FIG. 10 is a plan view of a piezoelectric device in a third modification in accordance with aspects of the present disclosure;

FIG. 11 is an elevational sectional view illustrating around a shaft member and a first bearing part of an ultrasonic motor according to a fourth modification in accordance with aspects of the present disclosure;

FIG. 12 is an elevational sectional view illustrating a portion where a spring member and a shaft member mate with each other in accordance with aspects of the present disclosure;

FIG. 13 is an elevational sectional view of an ultrasonic motor according to a fifth modification in accordance with aspects of the present disclosure;

FIG. 14 is a plan view of a spring member in a sixth modification in accordance with aspects of the present disclosure;

FIG. 15 is a plan view of a spring member in a seventh modification in accordance with aspects of the present disclosure;

FIG. 16 is an elevational sectional view illustrating a portion where a spring member and a shaft member mate with each other in accordance with aspects of the present disclosure;

FIG. 17 is a schematic view using a sectional view of the spring member and a front view of the shaft member for illustrating motion of the spring member during positioning of the spring member in accordance with aspects of the present disclosure;

FIG. 18 is an elevational sectional view illustrating a portion where a spring member and a shaft member mate with each other in a modification in accordance with aspects of the present disclosure;

FIG. 19 is an elevational sectional view illustrating a portion where a spring member and a shaft member mate with each other in accordance with aspects of the present disclosure; and

FIG. 20 is an elevational sectional view illustrating a portion where a spring member and a shaft member mate with each other in accordance with aspects of the present disclosure;.

### DETAILED DESCRIPTION

Hereinbelow, aspects of the present disclosure will be described. In a following description of the drawings, the same or similar components will be represented with use of the same or similar reference characters. The drawings are exemplary, sizes or shapes of portions are schematic, and technical scope of the present disclosure should not be understood with limitation to the aspects.

It is noted that the aspects described herein are merely illustration, and partial replacement or combination of configurations is possible between different aspects.

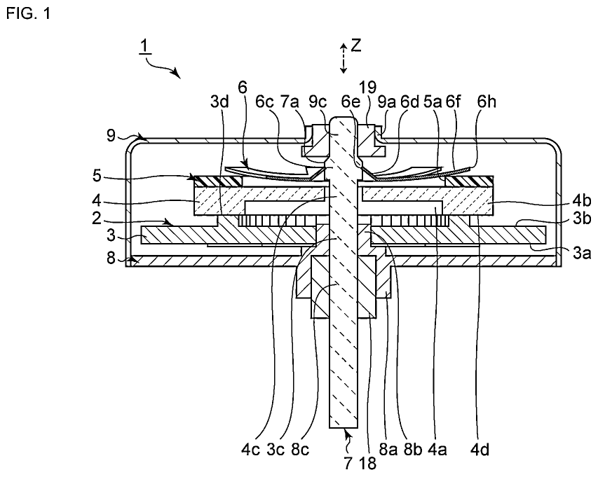

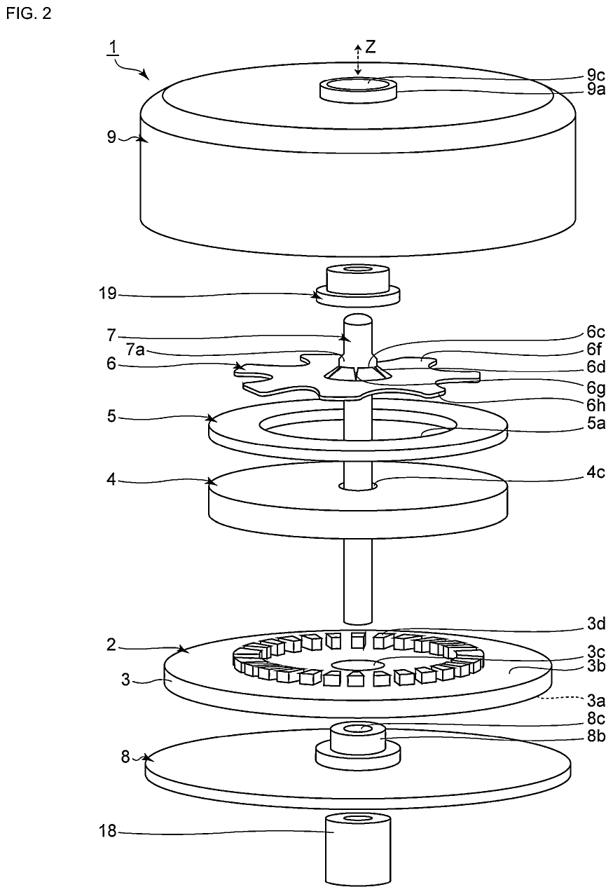

FIG. 1 is an elevational sectional view of an ultrasonic motor in accordance with aspects of the present disclosure. FIG. 2 is an exploded perspective view of the ultrasonic motor according to aspects of the present disclosure.

As illustrated in FIG. 1, an ultrasonic motor 1 includes a stator 2, a rotor 4, a plate-shaped spring member 6, and a shaft member 7. The stator 2 and the rotor 4 are in contact with each other. The spring member 6 gives elastic force to the rotor 4 toward a stator 2 side. Therefore, the rotor 4 is pushed against the stator 2. A traveling wave generated in the stator 2 rotates the rotor 4. Here, the spring member 6 and the shaft member 7 mate with each other. The rotor 4 and the shaft member 7 are integrated with each other with the spring member 6 interposed therebetween. Thus, the shaft member 7 also rotates accompanying with rotation of the rotor 4. Concrete configurations of the ultrasonic motor 1 are described below.

As illustrated in FIG. 2, the stator 2 includes a vibrating body 3. The vibrating body 3 has a disc shape. The vibrating body 3 has a first principal surface 3a and a second principal surface 3b. The first principal surface 3a and the second principal surface 3b are opposed to each other. Herein, an axial direction Z is a direction connecting the first principal surface 3a to the second principal surface 3b and along a rotation center. In this aspect, the axial direction Z is in parallel with a direction in which the shaft member 7 extends. The vibrating body 3 includes a through hole 3c at a center portion thereof. Note that the position of the through hole 3c is not limited to the position described above as long as the through hole 3c is positioned in a range including the center of the axial direction. Moreover, the shape of the vibrating body 3 is not limited to the disc shape. The shape of the vibrating body 3 when viewed in the axial direction Z may be a regular polygonal shape (for example, a regular hexagon, a regular octagon, or a regular decagon). Herein, the polygonal shape includes a shape whose vertex portions have a curved shape or a chamfered shape. The vibrating body 3 is made of suitable metal. Note that the vibrating body 3 does not have to be made of metal. For example, the vibrating body 3 may be made of a ceramic or another elastic material, such as silicon member and synthetic resin.

Herein, a direction viewed in the axial direction Z may be referred to as plan view or bottom view. Note that plan view is a direction viewed from above and bottom view is a direction viewed from below in FIG. 1. For example, a direction of viewing from the second principal surface 3b side to the first principal surface 3a side of the vibrating body 3 is plan view, and a direction of viewing from the first principal surface 3a side to the second principal surface 3b side is bottom view.

AS illustrated in FIG. 1, the rotor 4 is in contact with the second principal surface 3b of the vibrating body 3. The rotor 4 has a disc shape. The rotor 4 includes a through hole 4c at a center portion thereof. Note that the position of the through hole 4c is not limited to the position described above as long as the through hole 4c is positioned in a range including the center of the axial direction. Moreover, the shape of the rotor 4 is not limited to the shape described above. The shape of the rotor 4 may be a regular polygonal shape (for example, a regular hexagon, a regular octagon, or a regular decagon) when viewed in the axial direction Z.

The spring member 6 gives elastic force to the rotor 4 through an elastic member 5. Note that the elastic member 5 does not have to be provided.

The spring member 6 includes an opening 6c at a center portion thereof. A convex portion 6d is provided to surround the opening 6c. The convex portion 6d is a portion bent in a direction from the stator 2 side to the rotor 4 side, in the spring member 6. More specifically, the convex portion 6d has a conical shape. A tip-end portion 6e of the convex portion 6d is an opening edge portion of the opening 6c.

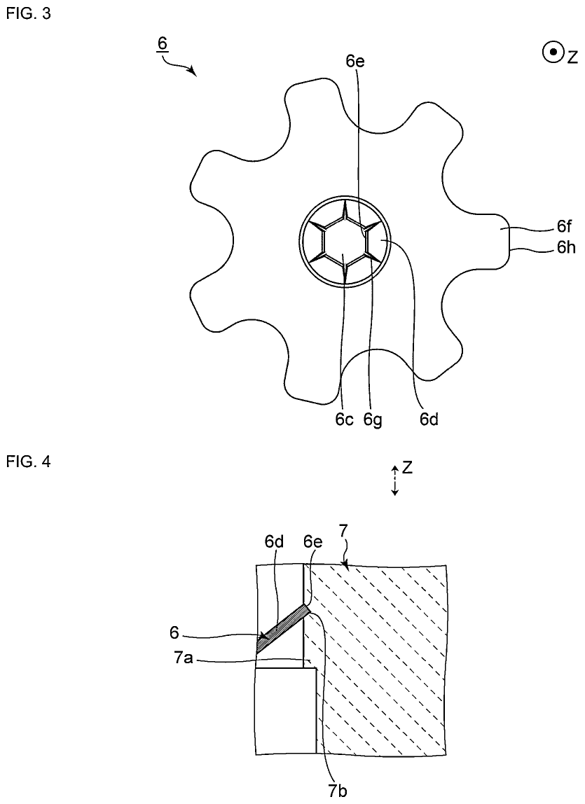

FIG. 3 is a plan view of the spring member in accordance with an aspect of the present disclosure.

The opening 6c of the spring member 6 has a hexagonal shape in plan view. Slit portions 6g extend in the convex portion 6d from the respective vertex portions of the hexagonal shape of the opening 6c. Note that the slit portions 6g do not have to be provided to the convex portion 6d. The shape of the opening 6c is not limited to the shape described above as long as it has a noncircular shape in plan view. The noncircular shape indicates, for example, a polygonal shape, an oval shape, a shape in which a curved line and a straight line are connected together, or a shape in which a curved line and a curved line are connected together.

The spring member 6 includes a plurality of beam portions 6f. The plurality of beam portions 6f are arranged radially in plan view. Elastic force caused by displacement of the plurality of beam portions 6f is given to the rotor 4. Note that the plurality of beam portions 6f do not have to be provided. The spring member 6 may have, for example, a circular shape or a regular polygonal shape in plan view.

FIG. 4 is an enlarged view of a portion where the spring member and the shaft member mate with each other in FIG. 1.

As illustrated in FIG. 4, the shaft member 7 has a mating portion 7a. The mating portion 7a is a portion mating with the spring member 6. The mating portion 7a has a hexagonal prism shape. Note that the shape of the mating portion 7a is not limited to the shape described above. For example, the shape of the mating portion 7a in plan view may be a polygonal shape, an oval shape, a shape in which a curved line and a straight line are connected together, or a shape in which a curved line and a curved line are connected together. The mating portion 7a has a groove portion 7b. The tip-end portion 6e of the convex portion 6d of the spring member 6 is positioned in the groove portion 7b. Thus, the spring member 6 and the shaft member 7 mate with each other. Note that, strictly speaking, the mating portion 7a includes a portion which is not mated with the spring member 6, that is, a portion which is not the groove portion 7b. Note that the spring member 6 and the shaft member 7 mating with each other means that the shape of the opening 6c of the spring member 6 is substantially similar to the sectional shape of the mating portion 7a of the shaft member 7 and the convex portion 6d of the spring member 6 is in contact with the mating portion 7a. More specifically, the shape of the opening 6c is the shape of the opening 6c in plan view. The sectional shape of the mating portion 7a is the shape of the mating portion 7a in the section taken in a direction orthogonal to the direction in which the shaft member 7 extends. Note that the shape of the opening 6c and the sectional shape of the mating portion 7a are preferably similar to each other. Herein, relation of being similar includes a case where a portion of one shape corresponding to a corner portion of the other shape has a curved shape or a chamfered shape.

Features of this aspect are that the shape of the opening 6c of the spring member 6 has a noncircular shape when viewed in the axial direction Z, the convex portion 6d projects in the direction from the stator 2 side to the rotor 4 side, and the tip-end portion 6e of the convex portion 6d mates with the mating portion 7a of the shaft member 7. Therefore, misalignment is less likely to be caused between the spring member 6 and the shaft member 7.

More specifically, since the opening 6c has a noncircular shape, misalignment in a circling direction is less likely to be caused between the spring member 6 and the shaft member 7. Moreover, by elastic force being given from the spring member 6 to the rotor 4, reaction force is applied to the spring member 6 from the rotor 4 side. Here, the direction in which the convex portion 6d of the spring member 6 projects is opposite from the direction in which the elastic force is given to the rotor 4. That is, the convex portion 6d projects in the direction in which the reaction force is applied to the spring member 6. Therefore, the tip-end portion 6e of the convex portion 6d is pushed against the mating portion 7a of the shaft member 7. In this manner, the force may be given all the time such that the spring member 6 and the shaft member 7 integrate with each other. Thus, even when the ultrasonic motor 1 is used over a long period of time and its members wear, loosening is less likely to be caused at the portion where the spring member 6 and the shaft member 7 mate with each other. As a result, misalignment is less likely to be caused between the spring member 6 and the shaft member 7.

As illustrated in FIG. 1, the ultrasonic motor 1 includes a first case member 8 and a second case member 9. The second case member 9 has a cap shape, and the first case member 8 has a lid shape. The first case member 8 and the second case member 9 constitute a case. The spring member 6, the rotor 4, and the stator 2 are disposed in the case.

The first case member 8 has a first cylindrically projecting portion 8a and a second cylindrically projecting portion 8b. The first cylindrically projecting portion 8a projects outside the case. The second cylindrically projecting portion 8b projects inside the case. The second cylindrically projecting portion 8b is inserted into the through hole 3c of the vibrating body 3 of the stator 2.

A through hole 8c is continuously provided to the first cylindrically projecting portion 8a and the second cylindrically projecting portion 8b. A width of the through hole 8c at a portion located at the first cylindrically projecting portion 8a is larger than a width of the through hole 8c at a portion located at the second cylindrically projecting portion 8b. Herein, unless particularly noted, a width of a through hole or an opening is a dimension of the through hole or the opening in a direction orthogonal to the axial direction Z. A first bearing part 18 is provided inside the through hole 8c at the portion located at the first cylindrically projecting portion 8a. The shaft member 7 is inserted into the through hole 8c and the first bearing part 18. The shaft member 7 projects outside the case from the through hole 8c of the first case member 8. Note that the configuration of the first case member 8 is not limited to the above.

The second case member 9 has a cylindrically projecting portion 9a. The cylindrically projecting portion 9a projects outside the case. The cylindrically projecting portion 9a includes a through hole 9c. A second bearing part 19 is provided inside the through hole 9c. The shaft member 7 is inserted into the through hole 9c and the second bearing part 19. The shaft member 7 projects outside the case from the through hole 9c of the second case member 9. Note that the configuration of the second case member 9 is not limited to the above. Bearings or the like may be used as the first bearing part 18 and the second bearing part 19, for example.

As illustrated in FIG. 1, the rotor 4 has a concave portion 4a and a side wall portion 4b. The concave portion 4a has a circular shape when viewed in the axial direction Z. The side wall portion 4b is a portion surrounding the concave portion 4a. The rotor 4 is in contact with the stator 2 at an end surface 4d of the side wall portion 4b. Note that the concave portion 4a and the side wall portion 4b do not have to be provided.

Friction material may be fixed to a surface of the rotor 4 on the stator 2 side. Thus, frictional force caused between the vibrating body 3 of the stator 2 and the rotor 4 can be stabilized. In this case, the rotor 4 can effectively be rotated, and the ultrasonic motor 1 can effectively be rotationally driven.

A plurality of protrusions 3d are provided on the second principal surface 3b of the vibrating body 3. The plurality of protrusions 3d are portions in contact with the rotor 4, in the vibrating body 3. Each protrusion 3d protrudes from the second principal surface 3b of the vibrating body 3 in the axial direction Z. The plurality of protrusions 3d are arranged in a circular ring shape when viewed in the axial direction Z. Since the plurality of protrusions 3d protrude from the second principal surface 3b in the axial direction Z, tip ends of the plurality of protrusions 3d are displaced further largely when a traveling wave is generated in the vibrating body 3. Therefore, the rotor 4 can effectively be rotated by the traveling wave generated in the stator 2. Note that the plurality of protrusions 3d do not have to be provided.

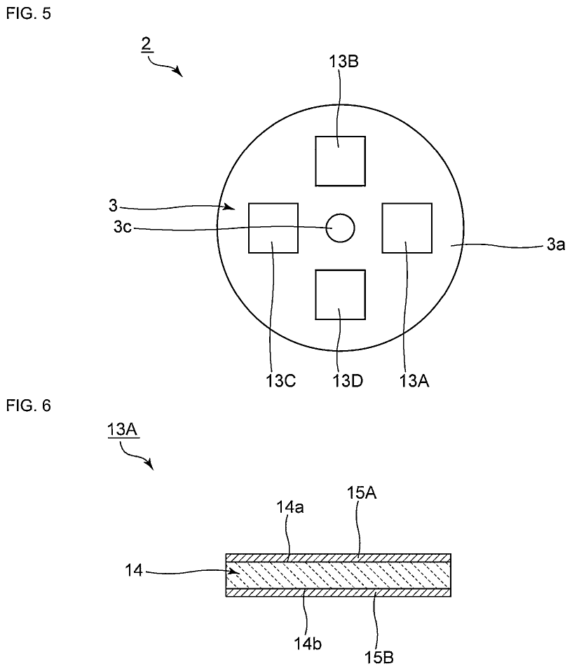

FIG. 5 is a bottom view of the stator in accordance with an aspect of the disclosure.

A plurality of piezoelectric devices are provided to the first principal surface 3a of the vibrating body 3. More specifically, the plurality of piezoelectric devices are a first piezoelectric device 13A, a second piezoelectric device 13B, a third piezoelectric device 13C, and a fourth piezoelectric device 13D. In order to generate a traveling wave which circles centering on an axis parallel to the axial direction Z, the plurality of piezoelectric devices are dispersedly arranged in a circling direction of the traveling wave. When viewed in the axial direction Z, the first piezoelectric device 13A and the third piezoelectric device 13C are opposed to each other with the axis therebetween. The second piezoelectric device 13B and the fourth piezoelectric device 13D are opposed to each other with the axis therebetween.

FIG. 6 is an elevational sectional view of the first piezoelectric device in one aspect.

The first piezoelectric device 13A includes a piezoelectric material 14. The piezoelectric material 14 has a third principal surface 14a and a fourth principal surface 14b. The third principal surface 14a and the fourth principal surface 14b are opposed to each other. The first piezoelectric device 13A includes a first electrode 15A and a second electrode 15B. The first electrode 15A is provided on the third principal surface 14a of the piezoelectric material 14, and the second electrode 15B is provided on the fourth principal surface 14b. The second piezoelectric device 13B, the third piezoelectric device 13C, and the fourth piezoelectric device 13D are also configured similarly to the first piezoelectric device 13A. Each piezoelectric device has a rectangular shape in plan view. Note that the shape of the piezoelectric device in plan view is not limited to the shape described above and may be an oval shape, for example. Here, the first electrode 15A is attached to the first principal surface 3a of the vibrating body 3 by adhesive. A thickness of the adhesive is extremely thin. Therefore, the first electrode 15A is electrically connected to the vibrating body 3.

Note, in order to generate a traveling wave, it is sufficient that the stator 2 includes at least the first piezoelectric device 13A and the second piezoelectric device 13B. Alternatively, the stator 2 may include a single piezoelectric device divided into a plurality of ranges. In this case, for example, the respective ranges of the piezoelectric device may be polarized in directions different from each other.

A structure of the stator 2 to generate a traveling wave by the plurality of piezoelectric devices being dispersedly arranged in a circling direction and being driven is disclosed in WO2010/061508A1, for example. Note that, in terms of the structure to generate the traveling wave, in addition to the following description, a configuration described in WO2010/061508A1 is hereby incorporated in its entirety.

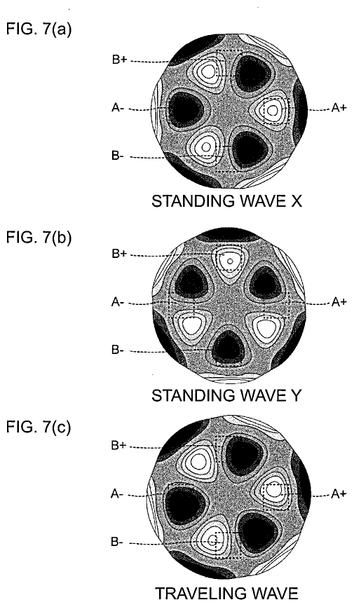

FIGS. 7(a) to 7(c) are schematic bottom views of the stator for illustrating a traveling wave excited in accordance with an aspect of the disclosure. Note that, in a grayscale in FIGS. 7(a) to 7(c), a color closer to black indicates a larger stress in one direction, and a color closer to white indicates a larger stress in the other direction. A curved solid line and a curved broken line in FIG. 7 schematically indicate a magnitude of vibration energy.

In FIG. 7(a), a standing wave X with a wavenumber of three is illustrated, and in FIG. 7(b), a standing wave Y with a wavenumber of three is illustrated. Assume that the first to fourth piezoelectric devices 13A to 13D are arranged having a central angle of 90° therebetween. In this case, since the three-wave standing waves X and Y are excited, a central angle with respect to a wavelength of the traveling wave is 120°. The central angle is determined by an angle of 90° obtained by multiplying an angle of 120° of one wave by three quarters. The first piezoelectric device 13A is disposed at a given position where an amplitude of the three-wave standing wave X is large, and the second to fourth piezoelectric devices 13B to 13D are disposed having an interval at the central angle of 90°. In this case, the three-wave standing waves X and Y having a phase difference at 90° in vibration are excited and synthesized, thus the traveling wave illustrated in FIG. 7(c) being generated.

Note that A+, A−, B+, and B− in FIGS. 7(a) to 7(c) indicate a polarization direction of the piezoelectric material 14. “+” means the polarization from the third principal surface 14a toward the fourth principal surface 14b in the thickness direction. “−” indicates the polarization in the opposite direction. “A” indicates the first piezoelectric device 13A and the third piezoelectric device 13C, and “B” indicates the second piezoelectric device 13B and the fourth piezoelectric device 13D.

Note that although the example where the wavenumber is three is described, it is not limited to this. Also in a case where the wavenumber is six, nine, twelve, or the like, two standing waves having a phase difference at 90° are similarly excited, and by the two standing waves being synthesized, a traveling wave is generated. In the present disclosure, the configuration to generate a traveling wave is not limited to the configuration illustrated in FIGS. 7(a) to 7(c), and various configurations known in the related art to generate a traveling wave can be used.

As illustrated in FIG. 1, the shaft member 7 is preferably not in contact with the rotor 4. In this aspect, although the shaft member 7 is inserted into the through hole 4c of the rotor 4, the shaft member 7 is not in contact with an opening edge portion of the rotor 4. Therefore, vibration of the rotor 4 is less likely to be propagated to the shaft member 7. Thus, the ultrasonic motor 1 can stably be driven.

In this aspect, a shape of the shaft member 7 at the portion inserted into the rotor 4 is a cylindrical shape. A shape of the through hole 4c of the rotor 4 when viewed in the axial direction Z is circle. Note that the shape of the above-mentioned portion of the shaft member 7 and the shape of the through hole 4c of the rotor 4 are not limited to the shapes described above.

A Young's modulus of the spring member 6 is preferably higher than a Young's modulus of the shaft member 7. Alternatively, a Vickers hardness of the spring member 6 is preferably higher than a Vickers hardness of the shaft member 7. In this aspect, the tip-end portion 6e of the convex portion 6d of the spring member 6 is positioned in the groove portion 7b of the shaft member 7. As a result of having the relation in terms of the Young's modulus or the Vickers hardness described above, the tip-end portion 6e of the convex portion 6d can further bite into the shaft member 7. Thus, the spring member 6 and the shaft member 7 can further firmly mate with each other. Accordingly, misalignment is further less likely to be caused between the spring member 6 and the shaft member 7.

Moreover, in the case of having the relation in terms of the Young's modulus or the Vickers hardness described above, the groove portion 7b does not have to be provided to the mating portion 7a of the shaft member 7 in advance. Since the tip-end portion 6e of the convex portion 6d of the spring member 6 is harder than the shaft member 7, the tip-end portion 6e bites into the mating portion 7a of the shaft member 7. More specifically, when the spring member 6 and the shaft member 7 mate with each other, the spring member 6 is displaced as illustrated in FIG. 1 when viewed in the axial direction. When viewed in the axial direction Z, the spring member 6 is displaced to be compressed toward the center. At this time, the spring member 6 is displaced such that a width of the opening 6c of the spring member 6 becomes smaller. Therefore, the tip-end portion 6e of the spring member 6 bites into the mating portion 7a of the shaft member 7. Then, the groove portion 7b is formed at the mating portion 7a, and the spring member 6 and the shaft member 7 mate with each other.

As material of the spring member 6, for example, stainless spring material (for example, SUS304-CSP and SUS301CSP-H), phosphor bronze, nickel silver, or the like may be used. As material of the shaft member 7, for example, SUS430, aluminum, brass, resin, or the like may be used. In these cases, the relation that the Young's modulus of the spring member 6 is higher than the Young's modulus of the shaft member 7 can be satisfied. Moreover, for example, when SUS430 is used as the material of the shaft member 7, the Vickers hardness is 200 HV or lower, and when SUS301CSP-H is used as the material of the spring member 6, the Vickers hardness is 430 HV or higher. In this manner, the relation that the Vickers hardness of the spring member 6 is higher than the Vickers hardness of the shaft member 7 can be satisfied. Thus, since the groove portion does not have to be provided to the mating portion 7a of the shaft member 7 in advance as described above, productivity can be improved.

When a dimension of the shaft member 7 in the direction orthogonal to the axial direction Z is a width of the shaft member 7, the width of the opening 6c of the spring member 6 in the state where the spring member 6 and the shaft member 7 do not mate with each other is preferably smaller than a width of the mating portion 7a of the shaft member 7 at a portion not including the groove portion 7b. Therefore, when the spring member 6 and the shaft member 7 are mated with each other, the tip-end portion 6e of the convex portion 6d of the spring member 6 can further strongly be pushed against the mating portion 7a of the shaft member 7. Thus, the spring member 6 and the shaft member 7 can further firmly be mated with each other.

Note that the width of the opening 6c changes accompanying with the displacement of the spring member 6. As described above, since the width of the opening 6c changes, the shaft member 7 can be inserted into the opening 6c even when the width of the opening 6c is small. By the spring member 6 being displaced as illustrated in FIG. 1 after the tip-end portion 6e of the convex portion 6d of the spring member 6 is brought into contact with the mating portion 7a of the shaft member 7, the spring member 6 and the shaft member 7 can suitably be mated with each other.

The shape of the opening 6c of the spring member 6 is preferably a polygonal shape when viewed in the axial direction Z. Moreover, the shape of the mating portion 7a of the shaft member 7 is preferably a polygonal shape when viewed in the axial direction Z. The shape of the opening 6c of the spring member 6 and the shape of the mating portion 7a of the shaft member 7 when viewed in the axial direction Z are preferably polygonal shapes having the same number of vertexes. Accordingly, the spring member 6 and the shaft member 7 can be made to contact with each other at sides of the polygonal shapes. Thus, misalignment in the circling direction is further less likely to be caused between the spring member 6 and the shaft member 7.

In one aspect of the disclosure, the spring member 6 and the shaft member 7 directly mate with each other without intervention of another member. Therefore, the number of components can be reduced, and cost reduction is possible.

In addition, the spring member 6 contacts the shaft member 7 at the tip-end portion 6e of the convex portion 6d. Therefore, a contact area between the spring member 6 and the shaft member 7 is small. Thus, vibration of the rotor 4 is further less likely to be propagated to the shaft member 7. As a result, the ultrasonic motor 1 can further stably be driven.

The convex portion 6d of the spring member 6 preferably includes the plurality of slit portions 6g. In this case, the convex portion 6d can easily be formed in a manufacturing process, which improves productivity.

When the plurality of slit portions 6g are provided, the convex portion 6d has a plurality of tip-end portions 6e. In this case, the mating portion 7a of the shaft member 7 preferably includes a plurality of groove portions 7b. Preferably, the plurality of groove portions 7b are dispersedly arranged in the circling direction and each groove portion 7b mates with the corresponding tip-end portion 6e. In this case, each tip-end portion 6e can be embedded into the shaft member 7, and therefore, each tip-end portion 6e is less likely to move in the circling direction. Thus, misalignment is further less likely to be caused between the spring member 6 and the shaft member 7.

The spring member 6 preferably includes the plurality of beam portions 6f. Therefore, displacement of the spring member 6 can easily be made larger. Thus, elastic force given to the rotor 4 by the spring member 6 may easily and more certainly be increased. As a result, the rotor 4 and the stator 2 may more certainly be made in close contact with each other, and the ultrasonic motor 1 may more certainly and effectively be driven.

The plurality of beam portions 6f are preferably arranged evenly in the circling direction. Therefore, the elastic force given to the rotor 4 can be made uniform in the circling direction. Thus, the ultrasonic motor 1 can stably be driven.

Further, the number of plurality of beam portions 6f is not an integral multiple of a wavenumber of a traveling wave and is a prime number. More specifically, a traveling wave with a wavenumber of three is utilized. In another aspect, the number of beam portions 6f is seven. Therefore, the spring member 6 is less likely to vibrate. Thus, vibration is less likely to be propagated to the shaft member 7, and the ultrasonic motor 1 can further stably be driven. In addition, occurrence of abnormal noise due to vibration of the spring member 6 can be suppressed.

A shape of a portion between the beam portions 6f of the spring member 6 when viewed in the axial direction Z is a curved shape. Therefore, concentration of stress is less likely to occur, and damage of the spring member 6 is less likely to be caused. Note that the shape of the spring member 6 is not limited to the shape described above. For example, the spring member 6 does not have to include the beam portion 6f.

The elastic member 5 is preferably provided between the spring member 6 and the rotor 4. Therefore, vibration of the rotor 4 is absorbed by the elastic member 5. Thus, vibration of the rotor 4 is less likely to be propagated to the spring member 6 and the shaft member 7. As a result, the ultrasonic motor 1 can stably be driven. As material of the elastic member 5, for example, rubber, resin, or the like may be used.

As illustrated in FIG. 2, the elastic member 5 has a ring shape. The elastic member 5 has an inner circumferential edge portion 5a. Meanwhile, the spring member 6 has an outer circumferential edge portion 6h. In this aspect, the outer circumferential edge portion 6h includes a tip-end portion of each beam portion 6f. The spring member 6 gives elastic force caused by displacement of the plurality of beam portions 6f to the rotor 4. Therefore, as illustrated in FIG. 1, in the ultrasonic motor 1, the spring member 6 is disposed in the state where the plurality of beam portions 6f are displaced. More specifically, the tip-end portions of the plurality of beam portions 6f are displaced to separate from the rotor 4.

The spring member 6 is in contact with the inner circumferential edge portion 5a of the elastic member 5. Moreover, the outer circumferential edge portion 6h of the spring member 6 is not in contact with the elastic member 5. Therefore, a contact area between the spring member 6 and the elastic member 5 can be made smaller. Thus, vibration from the rotor 4 side is less likely to be propagated to the spring member 6 and the shaft member 7. As a result, the ultrasonic motor 1 can further stably be driven.

First to fourth modifications of one aspect of the disclosure in which a configuration of a spring member, a piezoelectric device, a shaft member, or the like is different from that in other aspects are described below. In each modification, similarly to the one aspect, misalignment is less likely to be caused between the spring member and the shaft member.

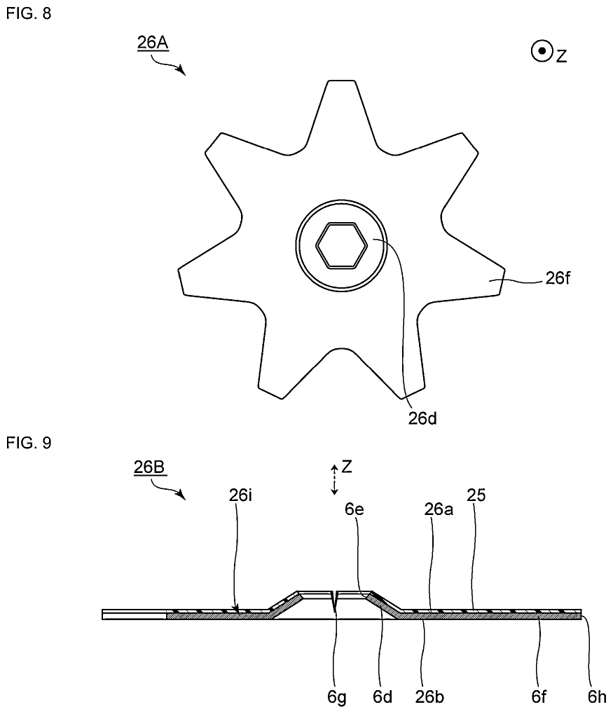

In the first modification illustrated in FIG. 8, shapes of a beam portion 26f and a convex portion 26d of a spring member 26A are different from those in the one aspect. More specifically, when a dimension of the beam portion 26f in a direction orthogonal to a direction in which the beam portion 26f extends when viewed in the axial direction Z is a width of the beam portion 26f, the width of the beam portion 26f becomes smaller away from the center of the spring member 26A. Therefore, stress applied to the beam portion 26f can be made uniform. Thus, the spring member 26A is further less likely to be damaged. Note that, in this modification, the convex portion 26d does not include a slit portion.

The second modification illustrated in FIG. 9 is different from the one aspect in that a spring member 26B includes an elastic layer 25. More specifically, the spring member 26B includes a body portion 26i. The body portion 26i has a configuration similar to that of the spring member 6 in the one aspect. Note that the body portion 26i has a first surface 26a and a second surface 26b. The first surface 26a and the second surface 26b are opposed to each other in the axial direction Z. Among the first surface 26a and the second surface 26b, the second surface 26b is located on the rotor 4 side. In this modification, the elastic layer 25 is provided to the entire surface of the first surface 26a. Therefore, vibration of the spring member 26B can be suppressed, and occurrence of abnormal noise due to vibration of the spring member 26B can further be suppressed. Moreover, vibration is further less likely to be propagated to the shaft member 7. Note that it is sufficient that the elastic layer 25 is provided to at least a portion of a surface of the body portion 26i. For example, the elastic layer 25 may be provided to a portion of the second surface 26b of the body portion 26i, or the elastic layer 25 may cover the entire surface of the body portion 26i.

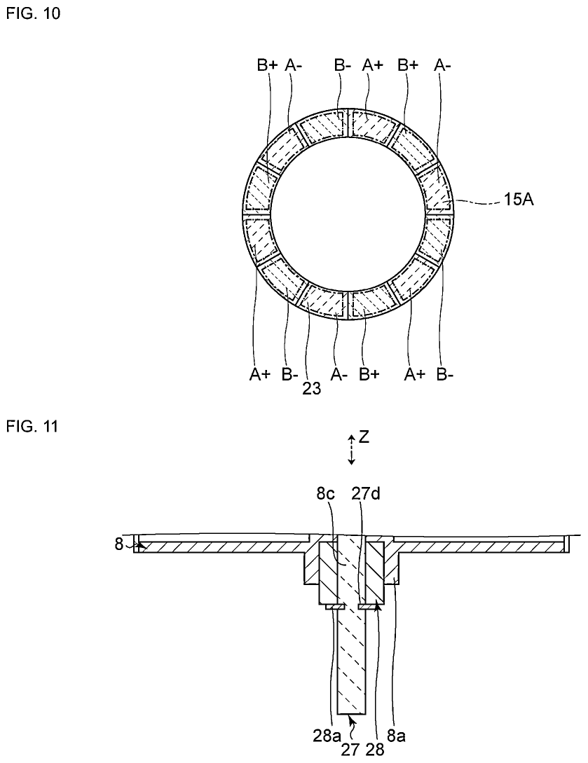

In the third modification illustrated in FIG. 10, a configuration of a piezoelectric device 23 is different from that in the one aspect. More specifically, the piezoelectric device 23 is a single piezoelectric device polarized into plural. The piezoelectric device 23 has a circular ring shape. The piezoelectric device 23 has a plurality of ranges. In FIG. 10, different ranges are indicated by different hatching. The piezoelectric device 23 has different polarization directions in the respective ranges. Therefore, the piezoelectric device 23 vibrates in different phases in the different ranges. The plurality of ranges are arranged in a circling direction in the piezoelectric device 23. More specifically, the plurality of ranges include a plurality of first A-phase ranges, a plurality of second A-phase ranges, a plurality of first B-phase ranges, and a plurality of second B-phase ranges. In the piezoelectric device 23, each range described above includes three ranges. Note that, in the piezoelectric device 23, it is sufficient that each range includes at least one range.

A piezoelectric material of the piezoelectric device 23 is polarized to be opposite polarization directions in the first A-phase range and the second A-phase range. Similarly, the piezoelectric material of the piezoelectric device 23 is polarized to be opposite polarization directions in the first B-phase range and the second B-phase range. That is, the piezoelectric device 23 is a piezoelectric device polarized into plural.

The piezoelectric device 23 includes a plurality of first electrodes 15A indicated by a one-dot chain line. Each first electrode 15A has an arc shape. The first electrodes 15A provided to the ranges adjacent to each other in the piezoelectric device 23 are not in contact with each other. Therefore, signals in phases which are different between the plurality of first and second A-phase ranges and the plurality of first and second B-phase ranges can be supplied. Note that a second electrode is provided to be opposed to the first electrode 15A with the piezoelectric material therebetween. A plurality of second electrodes may be provided similarly to the plurality of first electrodes 15A, or a single second electrode in a circular ring shape may be provided.

The fourth modification illustrated in FIG. 11 is different from the one aspect in that a shaft member 27 and a first bearing part 28 mate with each other. The shaft member 27 has a groove portion 27d. The first bearing part 28 includes a retaining ring 28a. The retaining ring 28a is positioned at an outer-side end portion of the first bearing part 28 in the axial direction Z. Note that the position of the retaining ring 28a is not limited to the position described above. An inner circumferential edge portion of the retaining ring 28a is positioned in the groove portion 27d of the shaft member 27. Therefore, the shaft member 27 and the first bearing part 28 mate with each other. In this configuration, misalignment of the shaft member 27 in the axial direction Z can effectively be suppressed.

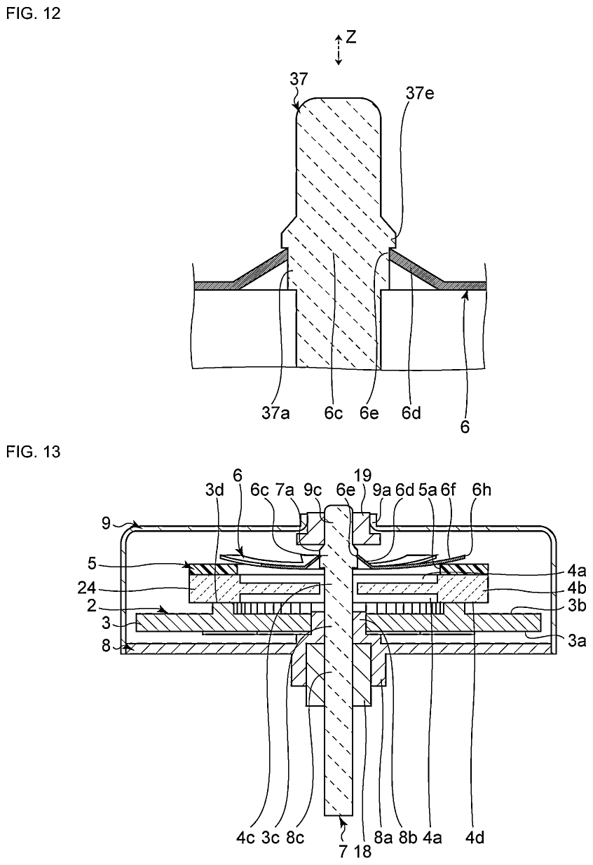

FIG. 12 is an elevational sectional view illustrating a portion where a spring member and a shaft member mate with each other in another aspect.

In one aspect of the disclosure, the width of the opening 6c of the spring member 6 and a configuration of a shaft member 37 are different from those in the one aspect. Configurations of an ultrasonic motor of this aspect other than the above points are similar to the configurations of the ultrasonic motor 1 of the one aspect.

A mating portion 37a of the shaft member 37 does not have a groove portion. The mating portion 37a has a protruding portion 37e. The protruding portion 37e projects in a direction orthogonal to the axial direction Z over the entire circling direction. The tip-end portion 6e of the convex portion 6d of the spring member 6 is in contact with the protruding portion 37e. Therefore, the spring member 6 and the shaft member 37 mate with each other. Note that the width of the opening 6c of the spring member 6 is the same as a width of the mating portion 37a of the shaft member 37 at a portion not including the protruding portion 37e.

Also in this aspect, the direction in which the convex portion 6d of the spring member 6 projects is opposite from the direction in which elastic force is given to the rotor 4. That is, the convex portion 6d projects in the direction in which reaction force is applied to the spring member 6 from the rotor 4 side. Therefore, the tip-end portion 6e of the convex portion 6d is pushed against the mating portion 37a of the shaft member 37. Thus, long-term use is less likely to cause loosening at the portion where the spring member 6 and the shaft member 37 mate with each other. As a result, similarly to the one aspect, misalignment is less likely to be caused between the spring member 6 and the shaft member 37.

The mating portion 37a of the shaft member 37 may have both of the groove portion and the protruding portion 37e. Similarly to the one aspect, the tip-end portion 6e of the convex portion 6d of the spring member 6 may be positioned in the groove portion. A portion of the convex portion 6d other than the tip-end portion 6e may be in contact with the protruding portion 37e. Also in this case, misalignment is less likely to be caused between the spring member 6 and the shaft member 37.

Meanwhile, the shape of the rotor 4 illustrated in FIG. 1 is not limited to the shape described above. For example, in a fifth modification of the one aspect illustrated in FIG. 13, a rotor 24 has a pair of concave portions 4a. One of the concave portions 4a is provided on the stator 2 side similarly to the one aspect. The other one of the concave portions 4a is provided on the spring member 6 side.

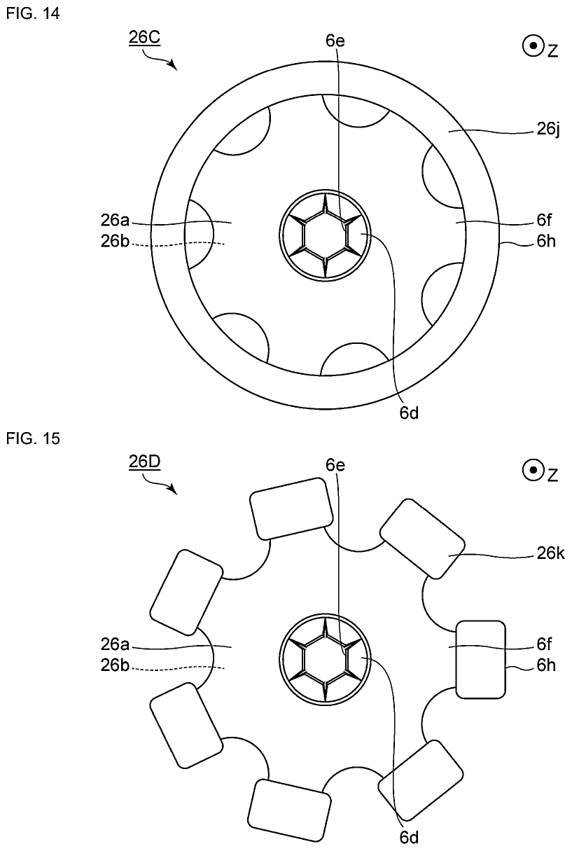

In a sixth modification of the one aspect illustrated in FIG. 14, a frame portion 26j is provided to connect the outer circumferential edge portions 6h of the plurality of beam portions 6f. In this modification, the frame portion 26j is provided as a separate body from the plurality of beam portions 6f. More specifically, the frame portion 26j is provided to the first surface 26a. The frame portion 26j has a circular ring shape. In this modification, since the frame portion 26j is provided, a posture of a spring member 26C can be stabilized. Therefore, misalignment between the spring member 26C and the shaft member 7 may further certainly be suppressed.

Note that the frame portion 26j may be provided not to the first surface 26a but to the second surface 26b. Alternatively, the frame portion 26j may be provided integrally with the plurality of beam portions 6f. The frame portion 26j does not have to reach the outer circumferential edge portion 6h of each beam portion 6f, as long as the frame portion 26j connects the beam portions 6f together. A shape of an outer circumferential edge of the frame portion 26j is not limited to a circular shape and may be a noncircular shape. Similarly, a shape of an inner circumferential edge of the frame portion 26j is not limited to a circular shape and may be a noncircular shape.

In a seventh modification of the one aspect illustrated in FIG. 15, each beam portion 6f is provided with a wide portion 26k at a portion including the outer circumferential edge portion 6h. A width of the wide portion 26k is larger than a width of the beam portion 6f at the other portion. In this modification, the wide portion 26k is provided as a separate body from the beam portion 6f. More specifically, the plurality of wide portions 26k are provided to the first surface 26a. The wide portion 26k has a rectangular shape. In this modification, since the wide portion 26k is provided to each beam portion 6f, a posture of a spring member 26D can be stabilized. Therefore, misalignment between the spring member 26D and the shaft member 7 may further certainly be suppressed.

Note that the plurality of wide portions 26k may be provided not to the first surface 26a but to the second surface 26b. Alternatively, the wide portion 26k may be provided integrally with the beam portion 6f. The wide portion 26k does not have to reach the outer circumferential edge portion 6h of the beam portion 6f. The shape of the wide portion 26k is not limited to the rectangular shape and may be, for example, a circular shape, or a noncircular shape other than the rectangular shape. The wide portion 26k in this modification and the frame portion 26j in the sixth modification are applicable to the configurations of the present disclosure.

In accordance with aspects of the disclosure described above, the tip end of the convex portion 6d of the spring member 6 has a planar shape. As illustrated in, for example, FIG. 4 or 12, both of two corner portions in a section of the tip-end portion 6e have a shape formed by a straight line and a straight line being connected. Note that the corner portion of the tip-end portion 6e may have a curved shape. This example is described below.

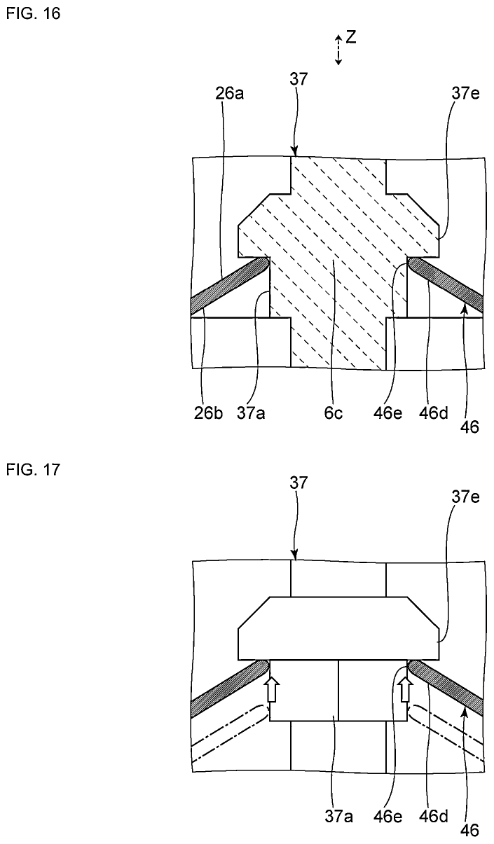

FIG. 16 is an elevational sectional view illustrating a portion where a spring member and a shaft member mate with each other in one aspect of the disclosure.

In one aspect of the disclosure, a tip end of a convex portion 46d of a spring member 46 has a curved surface. Configurations of an ultrasonic motor of this aspect other than the above point are similar to the configurations of the ultrasonic motor of other aspects.

In accordance with aspects of the disclosure, a tip-end portion 46e of the convex portion 46d of the spring member 46 is in contact with the protruding portion 37e of the shaft member 37. Therefore, the spring member 46 and the shaft member 37 mate with each other. Then, by reaction force being applied to the spring member 46 from the rotor 4 side, the tip-end portion 46e is pushed against the protruding portion 37e. Therefore, loosening is less likely to be caused at the portion where the spring member 46 and the shaft member 37 mate with each other. As a result, misalignment is less likely to be caused between the spring member 46 and the shaft member 37.

Moreover, the tip-end portion 46e of the convex portion 46d has a curved surface. Therefore, as illustrated in FIG. 17, the tip-end portion 46e can easily be slid on a surface of the mating portion 37a during mating of the spring member 46 and the shaft member 37. Thus, the tip-end portion 46e may more certainly be brought to reach the protruding portion 37e, and positioning of the spring member 46 may more certainly be performed.

In the configuration, the spring member 46 and the shaft member 37 preferably have at least one of relation that a Young's modulus of the spring member 46 is lower than a Young's modulus of the shaft member 37 and relation that a Vickers hardness of the spring member 46 is lower than a Vickers hardness of the shaft member 37. In this case, the tip-end portion 46e of the spring member 46 is less likely to bite into the shaft member 37. Therefore, the tip-end portion 46e may more certainly be slid on the surface of the mating portion 37a of the shaft member 37. As a result, positioning of the spring member 46 may further certainly be performed. Note that, for example, when SUS430 is used as material of the shaft member 37, C5191-1/2H (phosphor bronze type 2), C7521-1/2H (nickel silver type 2), or the like may be used as material of the spring member 46. In these cases, the Vickers hardness of the spring member 46 is lower than the Vickers hardness of the shaft member 37. Note that it is also possible that the Young's modulus of the spring member 46 is higher than the Young's modulus of the shaft member 37 and the Vickers hardness of the spring member 46 is higher than the Vickers hardness of the shaft member 37.

As illustrated in FIG. 16, both of two corner portions in a section of the tip-end portion 46e have a curved shape. More specifically, in a section parallel to the axial direction Z and passing through the center of the shaft member 37, both the corner portions of the tip-end portion 46e on the first surface 26a side and on the second surface 26b side have a curved shape. Note that it is sufficient that at least the corner portion on the second surface 26b side has a curved shape in the section.

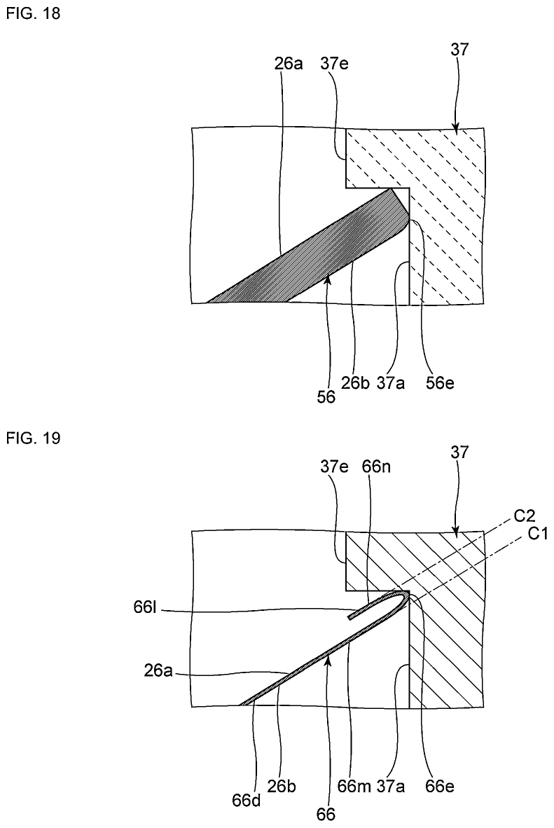

For example, as illustrated in FIG. 18, a corner portion on the first surface 26a side in a section of a tip-end portion 56e has a shape formed by a straight line and a straight line being connected together. On the other hand, a corner portion on the second surface 26b side has a curved shape. A portion of a spring member 56 which contacts the shaft member 37 is the corner portion on the second surface 26b side. Therefore, when this corner portion has a curved shape, the tip-end portion 56e of the spring member 56 can easily be slid on the surface of the mating portion 37a of the shaft member 37. As a result, positioning of the spring member 56 may more certainly be performed. In addition, misalignment is less likely to be caused between the spring member 56 and the shaft member 37.

Moreover, in this modification, the tip-end portion 56e of the spring member 56 including the curved surface can easily be formed by press punching processing. Thus, productivity can be improved.

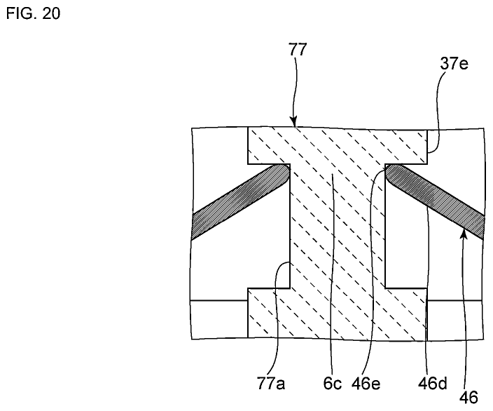

FIG. 19 is an elevational sectional view illustrating a portion where a spring member and a shaft member mate with each other in one aspect.

In accordance with an aspect of the disclosure, a portion including a tip-end portion 66e of a convex portion 66d of a spring member 66 includes a folding portion 66l. Further, a bent portion of the folding portion 66l is the tip-end portion 66e of the convex portion 66d. Configurations of an ultrasonic motor of this aspect other than the above points are similar to the configurations of the ultrasonic motor described above.

In the folding portion 66l, a portion where the first surfaces 26a are opposed to each other is positioned on the inside. A portion of the second surface 26b of the tip-end portion 66e of the convex portion 66d is in contact with the shaft member 37. Further, the tip-end portion 66e has a curved surface. Therefore, positioning of the spring member 66 may more certainly be performed. In addition, misalignment is less likely to be caused between the spring member 66 and the shaft member 37.

The folding portion 66l includes a first portion 66m and a second portion 66n. The first portion 66m and the second portion 66n are connected to each other at the bent portion of the folding portion 66l. The first portion 66m is a portion on a proximal end side of the convex portion 66d. In a section parallel to the axial direction Z and passing through the center of the shaft member 37, assuming that an angle formed between an extension line C1 of the first portion 66m and an extension line C2 of the second portion 66l is θ, in this aspect, θ=0° holds. In other words, a bending angle of the folding portion 66l is 180°. Note that the angle θ is not limited to 0°. The angle θ is preferably equal to or smaller than an angle formed between the extension line C1 of the first portion 66m and a plane orthogonal to the axial direction Z. Therefore, the tip-end portion 66e of the convex portion 66d can easily be brought into contact with the protruding portion 37e of the shaft member 37.

FIG. 20 is an elevational sectional view illustrating a portion where a spring member and a shaft member mate with each other in accordance with an aspect of the disclosure.

In this aspect, a width of a mating portion 77a of a shaft member 77 at a portion other than the protruding portion 37e is smaller than a width of the shaft member 77 at a portion other than the mating portion 77a. Configurations of an ultrasonic motor of this aspect other than the above point are similar to the configurations of the ultrasonic motor described above. Note that the portion of the mating portion 77a other than the protruding portion 37e has a hexagonal prism shape.

Further, positioning of the spring member 46 may more certainly be performed. In addition, misalignment is less likely to be caused between the spring member 46 and the shaft member 37. Moreover, the protruding portion 37e can be formed at the same time as forming the mating portion 77a, thus processing being easier. As a result, productivity can be improved.

In general, the description of the aspects disclosed should be considered as being illustrative in all respects and not being restrictive. The scope of the present disclosure is shown by the claims rather than by the above description, and is intended to include meanings equivalent to the claims and all changes in the scope. While preferred aspects of the invention have been described above, it is to be understood that variations and modifications will be apparent to those skilled in the art without departing from the scope and spirit of the invention.

### DESCRIPTION OF REFERENCE SYMBOLS

1 ultrasonic motor
2 stator
3 vibrating body
3a, 3b first principal surface, second principal surface
3c through hole
3d protrusion
4 rotor
4a concave portion
4b side wall portion
4c through hole
4d end surface
5 elastic member
5a inner circumferential edge portion
6 spring member
6c opening
6d convex portion
6e tip-end portion
6f beam portion
6g slit portion
6h outer circumferential edge portion
7 shaft member
7a mating portion
7b groove portion
8 first case member
8a, 8b first cylindrically projecting portion, second cylindrically projecting portion
8c through hole
9 second case member
9a cylindrically projecting portion
9c through hole
13A to 13D first piezoelectric device to fourth piezoelectric device
14 piezoelectric material
14a, 14b third principal surface, fourth principal surface
15A, 15B first electrode, second electrode
18, 19 first bearing part, second bearing part
23 piezoelectric device
24 rotor
25 elastic layer
26A, 26B, 26C, 26D spring member
26a, 26b first surface, second surface
26d convex portion
26f beam portion
26i body portion
26j frame portion
26k wide portion
27 shaft member
27d groove portion
28 first bearing part
28a retaining ring
37 shaft member
37a mating portion
37e protruding portion
46 spring member
46d convex portion
46e tip-end portion
56 spring member
56e tip-end portion
66 spring member
66d convex portion
66e tip-end portion
66l folding portion
66m, 66n first portion, second portion
77 shaft member
77a mating portion

We claim:

1. An ultrasonic motor comprising:
a stator including a vibrating body in a plate shape with a first principal surface and a second principal surface that oppose each other, and including a piezoelectric device on the first principal surface of the vibrating body;
a rotor in contact with the second principal surface of the vibrating body;
a spring in a plate shape having an opening and configured to generate an elastic force to the rotor in a direction from a side of the rotor to a side of the stator; and
a shaft inserted into the opening of the spring and including a mating portion,
wherein a shape of the opening of the spring is a noncircular shape in a plan view thereof.

2. The ultrasonic motor according to claim 1, wherein the spring includes a convex portion bent in a direction from the side of the stator to the side of the rotor, and an opening edge portion of the opening is configured to mate with the mating portion of the shaft, the opening edge portion being a tip-end of the convex portion.

3. The ultrasonic motor according to claim 2, wherein the mating portion of the shaft includes a groove, and the tip-end of the convex portion of the spring is positioned in the groove so that the spring and the shaft are configured to mate with each other.

4. The ultrasonic motor according to claim 1, wherein the shaft does not physically contact the rotor.

5. The ultrasonic motor according to claim 1, wherein the spring and the shaft have at least one of a relation that a Young's modulus of the spring is higher than a Young's modulus of the shaft or a relation that a Vickers hardness of the spring is higher than a Vickers hardness of the shaft.

6. The ultrasonic motor according to claim 1, wherein the shape of the opening of the spring is a polygonal shape in the plan view.

7. The ultrasonic motor according to claim 2, wherein the shape of the opening of the spring is a polygonal shape in the plan view.

8. The ultrasonic motor according to claim 7, wherein the convex portion of the spring includes a plurality of slits extending from a plurality of vertex portions of the polygonal shape of the opening.

9. The ultrasonic motor according to any one of claim 1, wherein the spring further includes a plurality of beams arranged radially in the plan view, and the spring is configured to generate an elastic force to the rotor by the plurality of beams.

10. The ultrasonic motor according to claim 9, wherein, when a direction connecting the first principal surface to the second principal surface of the vibrating body and along a rotation center is an axial direction, and when a direction circling centering on the axial direction is a circling direction, the plurality of beams of the spring are arranged evenly in the circling direction.

11. The ultrasonic motor according to claim 9, wherein the piezoelectric device is configured to vibrate the vibrating body to generate a traveling wave, and a number of the plurality of beams is not an integral multiple of a wavenumber of the traveling wave and is a prime number.

12. The ultrasonic motor according to claim 9, wherein, when a dimension of each of the plurality of beam portions in a direction orthogonal to a direction in which a beam of the plurality of beams extends is a width of the beam, the width of the beam becomes smaller away from a center of the spring in the plan view.

13. The ultrasonic motor according claim 1, wherein the spring includes a body portion and an elastic layer provided to at least a portion of a surface of the body portion.

14. The ultrasonic motor according to claim 1, further comprising:
an elastic between the spring and the rotor, and
wherein the spring is configured to generate elastic force to the rotor through the elastic.

15. The ultrasonic motor according to claim 14, wherein the elastic is in a ring shape and has an inner circumferential edge portion, and the spring has an outer circumferential edge portion.

16. The ultrasonic motor according to claim 15, wherein the spring is in physical contact with the inner circumferential edge portion of the elastic, and the outer circumferential edge portion of the spring is not in physical contact with the elastic.

17. The ultrasonic motor according to claim 2, wherein the mating portion of the shaft includes a protruding portion, and the convex portion of the spring is in physical contact with the protruding portion.

18. The ultrasonic motor according to claim 1, wherein the shape of the opening of the spring in the plan view corresponds to a shape of the mating portion of the shaft in a section taken in a direction orthogonal to a direction in which the shaft extends.

19. An ultrasonic motor comprising:
a stator including a vibrating body in a plate shape having a first principal surface and a second principal surface that oppose each other, and including a piezoelectric device on the first principal surface of the vibrating body;
a rotor in contact with the second principal surface of the vibrating body;
a spring in a plate shape having an opening and configured to generate an elastic force to the rotor in a direction from a side of the rotor to a side of the stator; and
a shaft inserted into the opening of the spring and including a mating portion,
wherein the spring has a convex portion bent in a direction from the side of the stator to the side of the rotor, and
wherein an opening edge portion of the opening mates with the mating portion of the shaft, the opening edge portion being a tip-end of the convex portion.

20. The ultrasonic motor according to claim 19, wherein a shape of the opening of the spring is a noncircular shape in a plan view thereof.
